(19) United States
(12) Patent Application Publication
(10) Pub. No.: US 2017/0178216 A1
(43) Pub. Date: Jun. 22, 2017

(54) Systems and Methods for Use in Determining Product Positions Within Shopping Regions

(71) Applicant: MASTERCARD INTERNATIONAL INCORPORATED, Purchase, NY (US)

(72) Inventors: Po Hu, Norwalk, CT (US); Shen Xi Meng, Millwood, NY (US); Jean-Pierre Gerard, Croton-On-Hudson, NY (US)

(21) Appl. No.: 14/978,686

(22) Filed: Dec. 22, 2015

(51) Int. Cl. G06Q 30/06; G06Q 30/02

(52) U.S. Cl. CPC G06Q 30/0625; G06Q 30/0639; G06Q 30/0641; G06Q 30/0261; G06Q 30/0255; G06Q 30/0267

(57) ABSTRACT

Exemplary embodiments of systems and methods are provided for locating products within a shopping region. In an exemplary embodiment, a method includes receiving, at a computing device, a request for a product from a consumer, and accessing, by the computing device, a product position data structure that is specific to the shopping region, where the product position data structure includes multiple product entries with each of the multiple product entries being specific to a merchant within the shopping region. The method also includes identifying at least one product entry, from the product position data structure, based on the request for the product received from the consumer, and then causing, by the computing device, via an internet-based application, a position of the identified at least one product entry to be displayed at a communication device associated with the consumer, relative to a position of the consumer in the shopping region.

### FIELD

The present disclosure generally relates to systems and methods for use in determining product positions within shopping regions, and in particular, to systems and methods for use in associating signal conditions to the product positions and retrieving the product positions in response to consumer queries.

### BACKGROUND

This section provides background information related to the present disclosure which is not necessarily prior art.

Products (e.g., goods, services, etc.) are known to be offered for sale, and to be sold, by merchants, often with different merchants offering the same or similar products. Consumers often shop at merchants based on the products offered by the merchants, special offers provided from the merchants, locations of the merchants relative to the consumers, convenience of the merchants, etc. Separately, shopping centers, which may include single merchants with multiple departments or multiple merchants associated within the centers or within a geographic location (e.g., a business district, a downtown area, etc.), are known to offer a wide variety of products to consumers. As such, consumers are able to conveniently shop at the shopping centers for multiple different products, potentially in different product categories. Given the disparate products offered by the merchants, the consumers often rely on categories or classifications of the merchants (e.g., as indicated by information kiosks at the shopping centers, advertisements by the merchants, etc.) to guide shopping activities to different parts of the shopping centers (e.g., to different departments within single merchants, or to different merchants within a shopping center, etc.), in search of the products desired for purchase.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in determining product positions within a shopping center;

FIG. 2 illustrates an exemplary layout of the shopping center included in the system of FIG. 1, indicating relative positions of multiple routers within the shopping center;

FIG. 3 is a block diagram of a computing device that may be used in the exemplary system of FIG. 1;

FIG. 4 illustrates an exemplary tag interface, suitable for use in the system of FIG. 1;

FIG. 5 is an exemplary method for use in determining product positions within a shopping center, which may be used in the system of FIG. 1;

FIG. 6 illustrates an exemplary hit interface, which may be used in the system of FIG. 1 and/or the method of FIG. 5, indicating identified products from a consumer search and illustrating the identified products on an exemplary layout of a shopping center; and

FIG. 7 illustrates an exemplary route interface, which may be used in the system of FIG. 1 and/or the method of FIG. 5, including directions to a selected one of the identified products in the hit interface of FIG. 6.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Shopping regions offer a wide variety of products for sale. Such shopping regions may include single merchants (e.g., department stores, etc.), or multiple merchants (e.g., at shopping centers such as malls; within geographic locations such as business districts, downtown areas, etc.; etc.). The diversity of products within the shopping regions often inhibits consumers from finding particular products of interest and/or efficiently traveling to such products when their positions are unknown. Uniquely, the systems and methods herein permit consumers to determine positions of certain products of interest (often relative to their own positions), whereby the consumers are able to efficiently locate the products of interest. In particular, merchant communication devices are employed within merchant locations at shopping regions, with which merchant employees “tag” the positions of certain products (e.g., by capturing and transmitting router signal intensities from the positions of the products, global positioning system (GPS) coordinates from the positions of the products, etc.). The tagged positions are stored in data structures, for the merchants, so that consumers may query the data structures and determine the actual locations of products of interest. The product positions may then be displayed, to the consumers, relative to the consumers' positions (also determined by router signal intensities, GPS signals, etc.). In this manner, the actual positions of products within the merchant locations (and within the broader shopping regions) are readily accessible to the consumers, such that estimating or guessing product locations, for example, by departments of merchants or by merchant categories, is unnecessary. In addition to product locations, certain other information about the products may also be displayed to the consumers, such as pricing, brands, special offers, consumer reviews, etc., which may be used by the consumers to make purchasing decisions when multiple products are consistent with the consumers' products of interest.

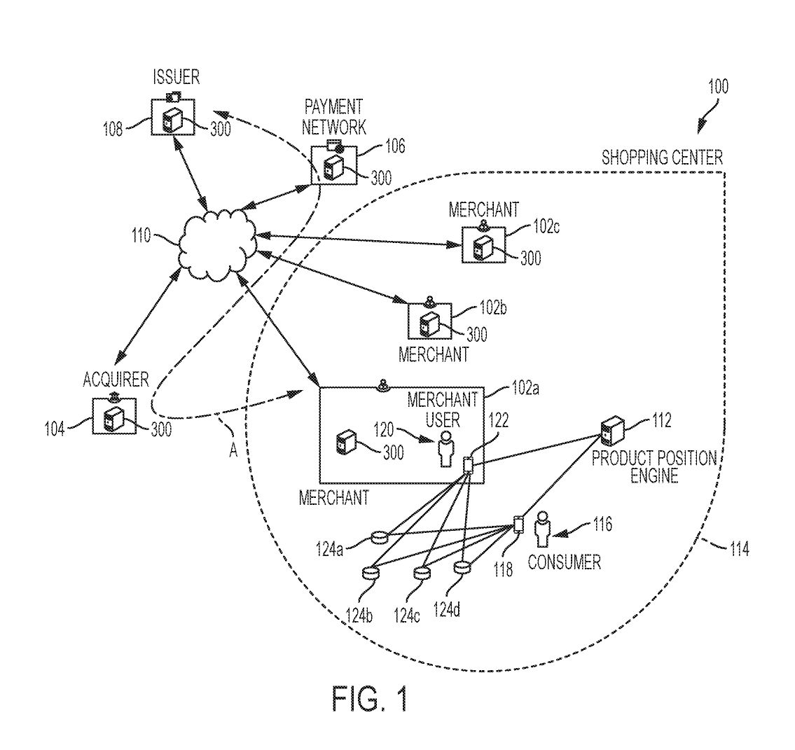

FIG. 1 illustrates an exemplary system 100, in which one or more aspects of the present disclosure may be implemented. Although, in the described embodiment, the system 100 is presented in one arrangement, other embodiments may include the system 100 arranged otherwise, depending, for example, on use, availability, locations and/or arrangements of routers, locations and/or arrangements of merchants, locations and/or arrangements of shopping regions, etc.

Referring to FIG. 1, the system 100 generally includes multiple merchants 102a-c, an acquirer 104, a payment network 106, and an issuer 108, each coupled to network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In multiple examples, the network 110 includes multiple networks, where different ones of the multiple networks are accessible to different ones of the illustrated parts in FIG. 1. For example, the network 110 may include a private payment transaction network made accessible by the payment network 106 to the acquirer 104 and the issuer 108 and, separately, a public network through which the merchants 102a-c and product position engine 112 may communicate (e.g., via a website or internet-based applications, etc.) as described more hereinafter.

In the system 100, the multiple merchants 102a-c are arranged in a shopping region illustrated, in this embodiment, as a shopping center and identified by the dotted reference 114. The shopping center 114 may include, without limitation, any shopping mall, precinct, arcade, complex, etc., or other conglomeration of multiple merchants, in generally one location, regardless of the products offered for sale by the merchants, configurations of structure(s) and/or building(s) associated therewith (e.g., open air, enclosed, etc.), etc. Further, while multiple merchants 102a-c are included in the illustrated shopping center 114, it should be appreciated that a shopping region (as used herein) may include the shopping center 114 or, alternatively, may include a region of merchants (e.g., a downtown shopping district, etc.) or only one merchant in other embodiments. In such embodiments where a shopping region includes a single merchant, the merchant will often include multiple different departments or be of sufficient size, whereby the operations described herein to locate products are of sufficient interest and/or value to the consumer and/or the one merchant.

The system 100 also includes a consumer 116, who purchases one or more products from one or more of the merchants 102a-c in the shopping center 114. In this exemplary embodiment, the merchants 102a-c, the acquirer 104, the payment network 106, and the issuer 108 cooperate, in response to a purchase request(s) from the consumer 116, for example, to complete payment account transaction(s) for purchase of the product(s).

For example, the consumer 116 may initiate a transaction with merchant 102a by presenting a payment device (e.g., a credit card, a debit card, a fob, a smartcard, an internet-based e-wallet application, etc.) to the merchant 102a. In turn, the merchant 102a receives the payment device (and payment account information associated therewith) and communicates an authorization request (e.g., including a payment account number and an amount of the purchase, etc.) to the acquirer 104 to determine whether the payment account is in good standing and whether there is sufficient finds and/or credit to cover the transaction. The authorization request is transmitted along path A in the system 100, as referenced in FIG. 1. The acquirer 104 communicates the authorization request with the issuer 108, through the payment network 106, such as, for example, through MasterCard®, VISA®, Discover®, American Express®, etc. In turn, if approved, an authorization reply (indicating the approval of the transaction) is transmitted back from the issuer 108 to the merchant 102a, along path A, thereby permitting the merchant 102a to complete the transaction. The transaction is later cleared and/or settled by and between the merchant 102a, the acquirer 104, and the issuer 108. If declined, however, the authorization reply (indicating a decline of the transaction) is provided back to the merchant 102a, along the path A, thereby permitting the merchant 102a to halt or terminate the transaction.

Transaction data is generated, collected, and stored as part of the above exemplary interactions among the merchant 102a, the acquirer 104, the payment network 106, the issuer 108, and the consumer 116. The transaction data includes a plurality of transaction records, one for each transaction, or attempted transaction. The transaction records, in this exemplary embodiment, are stored at least by the payment network 106 (e.g., in a data structure associated with the payment network 106, etc.). Additionally, or alternatively, the merchant 102a, the acquirer 104, and/or the issuer 108 may store the transaction records in corresponding data structures, or transaction records may be transmitted between parts of system 100. The transaction records may include, for example, payment account numbers, amounts of the transactions, merchant IDs, and dates/times of the transactions. It should be appreciated that more or less information related to transactions, as part of either authorization or clearing and/or settling, may be included in transaction records and stored within the system 100, at the merchant 102a, the acquirer 104, the payment network 106 and/or the issuer 108.

In the embodiments herein, consumers (e.g., consumer 116, etc.) involved in the different transactions are prompted to agree to legal terms associated with their payment accounts, for example, during enrollment in their accounts, etc. In so doing, the consumers voluntarily agree, for example, to allow merchants, issuers, payment networks, etc., to use transaction data generated and/or collected during enrollment and/or in connection with processing the transactions, for subsequent use in general, and as described herein.

As also shown in FIG. 1, the consumer 116 is associated with a communication device 118, and in particular, a portable communication device (e.g., a smartphone, a tablet, etc.). The portable communication device 118 generally moves with the consumer 116, as the consumer 116 moves from location to location within the shopping center 114. The merchant 102a also includes a merchant user 120 (e.g., an employee, a sales person, a manager, etc.), who is associated with a portable communication device 122 (e.g., a smartphone, a tablet, etc.). While only one consumer 116, one consumer communication device 118, one merchant user 120, and one merchant communication device 122 are illustrated in the system 100 of FIG. 1, it should be understood that multiple ones of these parts may be included in other system embodiments. For example, one or more of the merchants 102b, 102c may include a merchant user having a merchant communication device, etc., performing as described herein.

Further, the system 100 includes multiple routers 124a-d. As used herein, the term “router” should be understood broadly to include a variety of different networking devices, which are capable of generating one or more wireless network(s) and/or providing availability to one or more network(s), often wireless network(s). The term “router” should thus be understood broadly to include different routers, switches, gateways, hotspots, modems, adapters, access points, etc. In the system 100, the routers 124a-d each generate and/or make available (i.e., but not necessarily accessible) at least one wireless network having a range, such that when communication devices 118, 122 are within the range, the communication devices 118, 122 are able to “see” the wireless network and associate a signal strength with the wireless network. Each of the routers 124a-d is also unhidden, so that each can be recognized by the portable communication devices 118, 122 (even when the portable communication devices 118, 122 are unable to access the wireless network provided thereby). With that said, it should be appreciated that the routers 124a-d may provide public, private, secured or unsecured networks.

The routers 124a-d are generally included in the shopping center 114, as shown in FIG. 1. In other embodiments, however, the routers 124a-d may be positioned proximate to the shopping center 114, or otherwise located, such that at least a part of the wireless network of each of the routers 124a-d overlaps at least a part of the shopping center 114, for example, and with the cumulative wireless networks then substantially covering the shopping center 114.

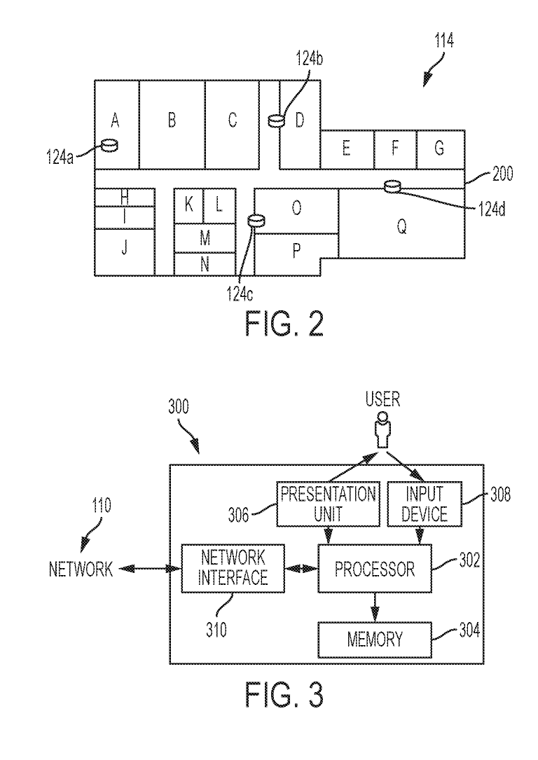

The position of the routers 124a-d within the shopping center 114 (or proximate to the shopping center 114) is generally determined in a manner that accounts for ranges of the wireless networks from the routers 124a-d. For example, FIG. 2 illustrates an exemplary layout 200 of the shopping center 114. The routers 124a-d are disposed, within the shopping center layout 200, so that regardless of where in the shopping center 114 the consumer 116 is positioned, the portable communication device 118 (associated with the consumer 116) is within range of at least two or at least three of the routers 124a-d. In this manner, generally, the portable communication device 118, regardless of its location within the shopping center 114, is able to view at least two networks from routers 124a-d and the signal strength (or intensities) associated with those router networks. It should be understood that the position of the routers 124a-d within the layout 200 in FIG. 2 is exemplary only, and that the number and/or positions of routers in other system embodiments may be different, for example, depending on a number of criteria, including, without limitation, sizes of shopping centers, number of floors of the shopping centers, structural compositions of the shopping centers, or other criteria that may affect a range of a network (or networks) provided by such routers, etc.

Further, it should be appreciated that one or more of the networks provided by routers 124a-d may be understood to be included in network 110. As such, the merchants 102a-c and/or the portable communication devices 118, 122 may be coupled to network 110, via one or more of the routers 124a-d, so that the one or more networks provided by the routers 124a-d are accessible to the portable communication devices 118, 122.

FIG. 3 illustrates an exemplary computing device 300 that can be used in the system 100. The computing device 300 may include, for example, one or more servers, workstations, personal computers, tablets, laptops, smartphones, PDAs, etc. In addition, the computing device 300 may include a single computing device, or it may include multiple computing devices located in close proximity or distributed over a geographic region, so long as the computing devices are specifically configured to function as described herein. However, the system 100 should not be considered to be limited to the computing device 300, as described below, as different computing devices and/or arrangements of computing devices may be used. In addition, different components and/or arrangements of components may be used in other computing devices.

In the exemplary embodiment of FIG. 1, each of the merchants 102a-c, the acquirer 104, the payment network 106, and the issuer 108 are illustrated as including, or being implemented in, a computing device 300, coupled to (and in communication with) the network 110. In addition, the product position engine 112, the portable communication devices 118, 122, associated with the consumer 116 and the merchant user 120, respectively, as well as the routers 124a-d can each be considered a computing device consistent with computing device 300 for purposes of the description herein.

The exemplary computing device 300 includes a processor 302 and a memory 304 coupled to (and in communication with) the processor 302. The processor 302 may include one or more processing units (e.g., in a multi-core configuration, etc.). For example, the processor 302 may include, without limitation, a central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein.

The memory 304, as described herein, is one or more devices that permit data, instructions, etc., to be stored therein and retrieved therefrom. The memory 304 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 304 may be configured to store, without limitation, a variety of data structures (e.g., product position data structures, etc.), position statements, position profiles and/or router intensity profiles for products, and/or other types of data (and/or data structures) suitable for use as described herein. Furthermore, in various embodiments, computer-executable instructions may be stored in the memory 304 for execution by the processor 302 to cause the processor 302 to perform one or more of the functions described herein, such that the memory 304 is a physical, tangible, and non-transitory computer readable storage media. Such instructions often improve the efficiencies and/or performance of the processor 302 that is performing one or more of the various operations herein. It should be appreciated that the memory 304 may include a variety of different memories, each implemented in one or more of the functions or processes described herein.

In the exemplary embodiment, the computing device 300 includes a presentation unit 306 that is coupled to (and in communication with) the processor 302 (however, it should be appreciated that the computing device 300 could include output devices other than the presentation unit 306, etc.). The presentation unit 306 outputs information, either visually or audibly to a user of the computing device 300, such as, for example, the consumer 116 associated with the portable communication device 118 or the merchant user 120 associated with the portable communication device 122, etc. It should be further appreciated that various interfaces (e.g., hit interfaces, router interfaces, etc. as defined by internet-based applications; etc.) may be displayed at computing device 300, and in particular at presentation unit 306, to display such information. The presentation unit 306 may include, without limitation, a liquid crystal display (LCD), a light-emitting diode (LED) display, an LED, an organic LED (OLED) display, an “electronic ink” display, speakers, etc. In some embodiments, presentation unit 306 includes multiple devices.

The computing device 300 also includes an input device 308 that receives inputs from the user (i.e., user inputs) such as, for example, requests for products of interest, selections of products of interest, etc. The input device 308 is coupled to (and in communication with) the processor 302 and may include, for example, a keyboard, a pointing device, a mouse, a button, a stylus, a touch sensitive panel (e.g., a touch pad or a touch screen, etc.), another computing device, and/or an audio input device. Further, in various exemplary embodiments, a touch screen, such as that included in a tablet, a smartphone, or similar device, behaves as both a presentation unit and an input device.

In addition, the illustrated computing device 300 also includes a network interface 310 coupled to (and in communication with) the processor 302 and the memory 304. The network interface 310 may include, without limitation, a wired network adapter, a wireless network adapter, a mobile network adapter, a GPS transmitter, a GPS receiver, combinations thereof, or other device capable of communicating to/with one or more different networks, including the network 110. Further, in some exemplary embodiments, the computing device 300 includes the processor 302 and one or more network interfaces 310 incorporated into or with the processor 302.

With reference again to FIG. 1, the product position engine 112 of the system 100 is configured, often by computer-executable instructions, to perform one or more of the operations described herein. In the exemplary embodiment, the product position engine 112 is included as a standalone part within the shopping center 114, and generally dedicated to the operations described herein. In other embodiments, however, the engine 112 may be incorporated into one or more of the computing devices 300 associated with the merchants 102a-c, or another computing device deployed at the shopping center 114, or apart from the shopping center 114, etc.

The product position engine 112 generally includes a product position data structure (not shown) stored in memory 304 of the engine 112, for example, which includes product entries for multiple products offered for sale through the shopping center 114. The product entries may include multiple different product entries for multiple different products. The product entries may also include multiple product entries for the same product, for example, when the same product is disposed at multiple positions in the shopping center 114, for example, for sale at multiple ones of the merchants 102a-c.

Each of the product entries in the data structure includes information about the corresponding product. Any desired information relevant to the product, or relevant to the consumer's decision to buy or not buy the product, etc., may be included. For example, and without limitation, the product information may include a name of the merchant at which the product is located, a product category, a product brand, a primary product functionality, pricing, customer ratings, return rates (in general, or per merchant), discount prices and/or offers for the product, recommendations, etc. In addition, some of the information in the product entries may be common to multiple product entries (e.g., for entries relating to the same product but involving different ones of merchants 102a-c; etc.). Such common information may be retrieved and/or received from a third party. For example, consumer reviews and/or primary product functionality for a product may be retrieved, via an application program interface (API), or by other means, from one or more consumer review entities (not shown) or from the products' manufacturers or distributors (not shown).

Generally, the product position engine 112 interacts with the portable communication device 122, associated with the merchant user 120, via an internet-based application (and executable instructions associated therewith) installed and active in the device 122, to perform different operations described herein. For example, the portable communication device 122 is configured, by the internet-based application, to tag positions in the merchant 102a (in response to inputs from the merchant user 120) as associated with products offered for sale by the merchant 102a. In particular, when a product is initially placed within the merchant 102a, or is moved within the merchant 102a, the merchant user 120 uses the portable communication device 122 to tag the position of the product.

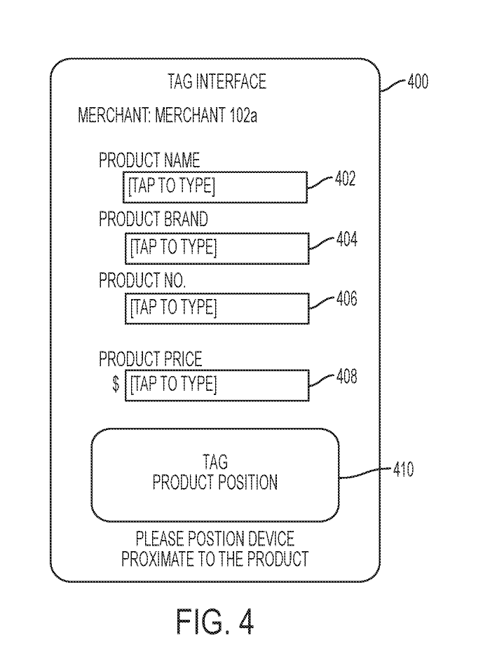

FIG. 4 illustrates an exemplary tag interface 400, which may be displayed to the user 120, by the internet-based application, at the portable communication device 122. The tag interface 400 generally includes the merchant name (i.e., merchant 102a) as well as a product name field 402, a product brand field 404, a product number field 406, and a product price field 408. As such, upon display of the tag interface 400 at the portable communication device 122, the merchant user 120 can enter certain information about the product, including the product name at field 402. the product brand at field 404, the product number at field 406, and the product price at field 408 (for the product at merchant 102a). It should be appreciated that other exemplary tag interfaces may be employed, and that the information solicited by the other interfaces may be different than illustrated for tag interface 400. For example, some of the same information may be included/requested (e.g., a product name and/or product number, etc.), while other information may not. Further, in some tag interfaces, different information than included in the tag interface 400 may be requested.

Once the requested product information is entered at the tag interface 400, by the merchant user 120, the merchant user 120 is invited to position the portable communication device 122 proximate to (e.g., within 6 inches, 1 foot, 2 feet, 5 feet, etc.) the corresponding product, and then provide an input to a tag interface 400 via button 410. In response, when the input to the button 410 is detected, the portable communication device 122 is configured to record (broadly, capture) signal strengths of ones of the routers 124a-d within range of the portable communication device 122. The portable communication device 122 is configured to then transmit a position statement (or position statement record or position record) to the product position engine 112. The position statement includes the recorded signal strengths of the ones of the routers 124a-d within range of the portable communication device 122 as well as the product information provided by the merchant user 120 to the tag interface 400. In turn, the product position engine 112 stores the position statement, and associated information including router intensity profiles for multiple ones of the routers 124a-d, for example, to the product position data structure (e.g., in a data structure in memory 304 of the engine 112, etc.) as part of the product entry for the product.

The product position engine 112 also interacts with the portable communication device 118 via an internet-based application (and executable instructions associated therewith) installed and active in the device 118, to perform different operations described herein. For example, the portable communication device 118 is configured, by the internet-based application, to capture router signal strengths (or intensities) for ones of the routers 124a-d, and to permit the consumer 116 to search for products in the shopping center 114.

Initially, when the consumer 116 and the portable communication device 118 enter the shopping center 114, the portable communication device 118 captures router signal strengths from ones of the routers 124a-d. As the consumer 116 and the portable communication device 118 move within the shopping center 114, the router signal strengths for the routers 124a-d, as received at the portable communication device 118, change. For accuracy, the signal strengths may be captured, by the portable communication device 118, at one or more regular or irregular intervals, or based on a movement, or based on one or more other criteria. In any case, the router signal strengths generally define position statements for the portable communication device 118 (and thus the consumer 116) within the shopping center 114. As such, after capturing the router signal strengths, the portable communication device 118 is configured to transmit the corresponding position statement, along with an application identifier (ID) or other indicia unique to the consumer 116 and/or the portable communication device 118, to the product position engine 112. In turn, the product position engine 112 receives the position statement, and identifies the location indicated thereby as a present position of the consumer 116 (until a subsequent position statement is received). The product position engine 112 may then be configured to store the position statement (and each subsequent position statement) of the consumer 116 in a data structure (e.g., in memory 304, etc.), for subsequent use.

When the consumer 116 elects to do so, the portable communication device 118, as configured by the internet-based application, permits the consumer 116 to request (e.g., search for, etc.) a product, by name, brand, category, or otherwise, etc. Upon receiving such an input from the consumer 116, the portable communication device 118 transmits the consumer's request to the product position engine 112. In turn, the product position engine 112 is configured to search in the product position data structure (e.g., in memory 304) for a product or products indicated by (or satisfying) the request, and identify matching products and their relative position to the consumer 116 based on a present position of the consumer 116 from a most recent position statement. The product position engine 112 is configured to then provide the product(s) identified from the search, if any, back to the portable communication device 118 to be displayed to the consumer 116 (e.g., in a map form with the position of each product noted, etc.). The product position engine 112 may also be configured to compile a consumer route (e.g., generate a path record for the consumer 116 based on the multiple position statements, etc.) through the shopping center 114 to one or more of the identified products, which may be used as described next.

Upon receiving the identified product(s) from the product position engine 112, via the consumer's portable communication device 118, the consumer 116 is permitted to select one of the product(s), whereby the portable communication device 118 is configured to display a route to the selected product (based on the consumer's present position). The route may be the consumer route compiled by the product position engine 112, or the route may be a route compiled by the consumer's portable communication device 118, for example, following selection of the product. As will be explained in more detail below, the product position engine 112 and the portable communication device 118 may interact in a variety of ways to enable the consumer 116 to find and navigate to the product (or any other products of interest), and potentially to receive offers and/or guidance from the engine 112 about potential products of interest (e.g., based on the consumer's request or prior requests, based on the consumer's path through the shopping center 114, etc.).

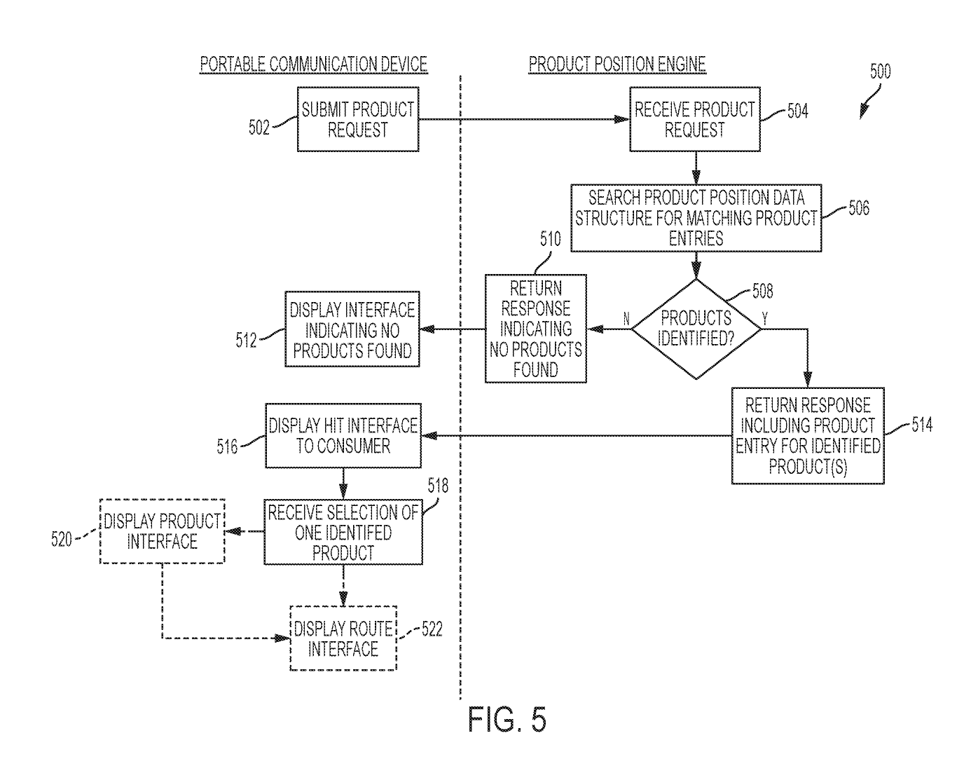

FIG. 5 illustrates an exemplary method 500 for determining positions of products within a shopping center. The method 500 is described with reference to the system 100, and in particular, as operations of the portable communication device 118 and the product position engine 112. It should be appreciated, however, that the methods described herein are not limited to the system 100. And, conversely, the systems described herein are not limited to the exemplary method 500.

As shown in FIG. 5, upon entering the shopping center 114 (or earlier or later), the consumer 116 enters a request for a target product to the portable communication device 118, via an interface (associated with the internet-based application on the portable communication device 118), which causes the product request to be submitted to the product position engine 112, at 502. The request may include, for example, a product name for the target product, a product number for the target product, a brand of the target product, a product category for the target product, combinations thereof, etc. Along with the request, the portable communication device 118 transmits, upon receiving permission or consent from the consumer 116, for example, an identifier (ID) unique to the internet-based application used by the portable communication device 118, the consumer 116, and/or the portable communication device 118 itself. The ID associates the request with the consumer 116, and also identifies the consumer 116 to the product position engine 112. In some embodiments, such identification may include transmittal of data included in a profile of the consumer 116 or other consumer data (e.g., transaction data, etc.) that may help facilitate an improved shopping experience for the consumer 116 (again, typically only upon permission or consent from the consumer 116, etc.).

In response, the product position engine 112 receives the request from the portable communication device 118, at 504. And, the product position engine 112 stores the request to a data structure (e.g., in memory 304 of the engine 112, etc.), for subsequent use as described herein.

Next, at 506, the product position engine 112 searches within the product position data structure for product entries consistent with the consumer's request (e.g., that match the target product included in the request, etc.). For example, when a product name (e.g., iPhone®, etc.) is included in the request for the target product, the product position engine 112 searches for product entries in the product position data structure that include the product name. Similarly, if the consumer's request includes a product brand (e.g., Apple®, etc.) for the target product, the product position engine 112 searches for product entries in the product position data structure that include that brand. The product position engine 112 may search the product position data structure via any suitable operations including, for example, key word searching, etc. In addition, in some embodiments, the product entries in the product position data structure may be categorized (e.g., by product category, etc.), such that the product position engine 112 may initially identify a category for searching and then perform the search within the identified category. In various embodiments, only products exactly matching the consumer's search query may be returned, while in other embodiments a listing of close matches may be provided (e.g., all products associated with a particular brand entered by the consumer 116, all brands associated with a particular product name entered by the consumer 116, all products within a common product class (e.g., all available tablets when the consumer 116 searches for an iPad®, etc.). Further, in various embodiments, matches may be fuzzy matches, or may be matches only at product group levels. For example, if the consumer 116 requests information about XYZ Men's Shoes, the product position engine 112 may, in response, provide matches for the requested specific shoes in different ones of the merchants 102a-c at the shopping center 114. The product position engine 112 may also provide other models of shoes in the same or similar brand, or similar other shoes that other people have expressed interest or purchased the most, or even other relevant options that have been learned or identified, by the engine 112, from other consumers (e.g., via searches, reviews, etc.).

When no matching product entries are identified by the product position engine 112 from the search, at 508, the product position engine 112 transmits a response to the portable communication device 118, at 510, indicating that no matching product entries were found. In such cases, the target product may not be available for sale at any of the merchants 102a-c at the shopping center 114, or the merchants 102a-c may not have the target product in stock. The response may include a particular indicator (e.g., a code, etc.) specifying that no matching product entries were found. Or, the response may simply include a text statement that no matches were found, or some other indicia such as an image, etc. indicating that no product entries were found. In turn, the portable communication device 118 receives the response from the product position engine 112 and displays to the consumer 116 (or causes to be displayed), at 512, an interface indicating that no matching products (or product entries) were found.

Alternatively in the method 500, when at least one matching product entry is identified by the product position engine 112 in the search, at 508, the product position engine 112 transmits a response to the portable communication device 118, at 514, that includes the identified product entry (or multiple identified product entries) for the target product. In so doing, the product position engine 112 may transmit, for each identified product entry, the entire product entry or a portion thereof, as desired. For example, in some embodiments, the product position engine 112 may simply transmit to the portable communication device 118 a name of the identified product and a location of the product within the shopping center 114.

Upon receiving the response from the product position engine 112, including the identified product entry, the portable communication device 118 displays to the consumer 116 (or causes to be displayed), at 516, a hit interface indicating the identified product entry. The hit interface may include a listing of matching products identified by the product position engine 112 during the search at 506, based on the consumer's request. Or, the target interface may include a listing of locations of products that match the criteria provided in the consumer's request. In addition, or alternatively, the hit interface may include a map of the shopping center 114 identifying the locations of the products and/or the merchants having the products that match the criteria provided in the consumer's request.

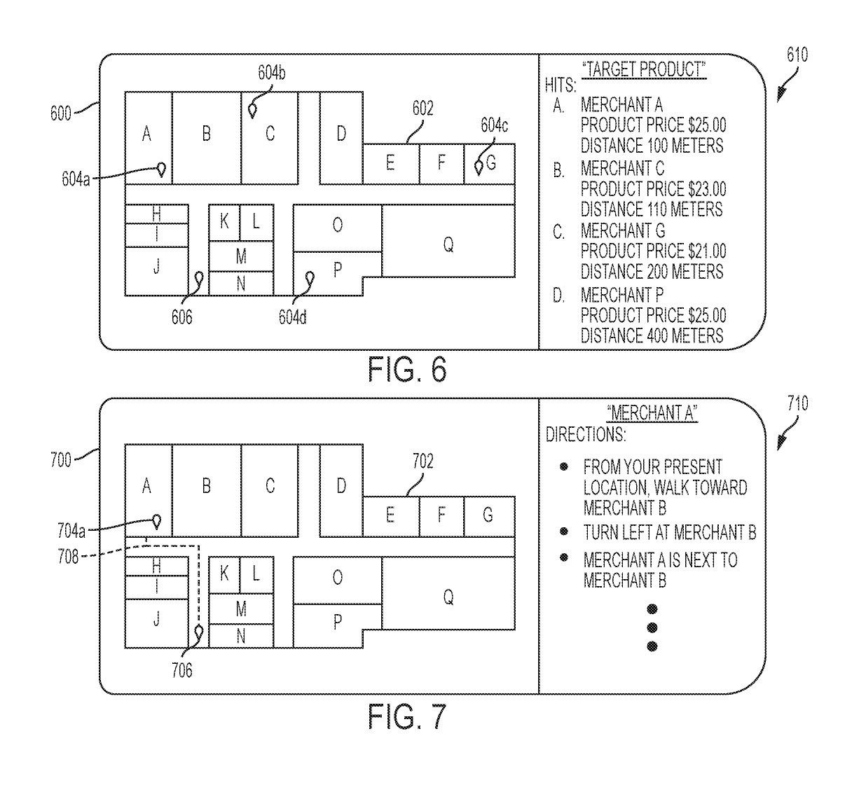

FIG. 6 illustrates an exemplary hit interface 600, which may be displayed to the consumer 116 at the portable communication device 118 (e.g., via the internet-based application at the device 118, etc.). In this example, the consumer 116 submitted a request for a particular target product by name, i.e., for an iPhone®. In response, the product position engine 112 identified four merchants (merchants A, C, G, P) (broadly, product entries) that offer the target product for sale. To present the information to the consumer 116, the hit interface 600 includes a map or layout 602 of the shopping center 114 that identifies, via position indicators 604a-d, locations of the target product (at the four merchants) within the shopping center 114. For reference, the hit interface also identifies a present position of the consumer 116 at pin 606 (as determined by a last position statement record received from the portable communication device 118). It should be appreciated that the position indicators 604a-d may include any desired indicators and, in some examples, may include a product name, a product number, or any other information about the product, etc. to help enable the consumer 116 to make an informed selection.

The exemplary hit interface 600 also includes a listing 610 of the four identified merchants. The listing provides a merchant name for each of the four merchants, their pricing information for the target product, and a relative distance thereto from the present position of the consumer 116. With that said, it should be appreciated that other exemplary hit interfaces may be employed, and that the information included in the other interfaces may be different (or displayed differently) than illustrated for hit interface 600. For example, other hit interfaces may include additional (or different) information from matching product entries identified by the product position engine 112, different formats for presenting the information to the consumer 116, etc.

With reference again to FIG. 5, upon displaying the hit interface to the consumer 116, the consumer 116 is allowed to select, via an input to the interface, the identified product entry (or one of multiple identified product entries, when found by the product position engine 112). In turn, the portable communication device 118 receives the selection (and user input), at 518.

In response, the portable communication device 118 optionally (as indicated by the dotted lines in FIG. 5) displays a product interface to the consumer 116, at 520, including product entry information about the product. For example, the product interface may include a name of the product, a manufacturer of the product, a category of the product, a brand of the product, a name of the merchant at which the product is located, directions from the consumer's present location to the merchant (or product), a distance from the consumer's present location to the merchant (or product), a number of the products currently in stock at the merchant, combinations thereof, etc. The product entry information may permit the consumer 116 to evaluate the product, prior to requesting a route or other directions to the product. It should be appreciated that when multiple identified product entries are included in the hit interface, the consumer 116, via the portable communication device 118, may be able to navigate between product interfaces for different identified ones of the product entries in the hit interface for comparison, as needed or desired. In at least one embodiment, the product interface includes information about multiple identified products, for ease of comparison by the consumer 116.

In addition in the method 500, or alternatively, the portable communication device 118 optionally (again as indicated by the dotted lines in FIG. 5) displays a route interface to the consumer, at 522, including a route from the consumer's present position to the selected identified product location. The route may be a route compiled by the product position engine 112, or it may be a route compiled by the consumer's portable communication device 118, for example, following selection of the product entry.

FIG. 7 illustrates an exemplary route interface 700, which may be displayed to the consumer 116 at the portable communication device 122 (e.g., via the internet-based application at the device 122, etc.), when the consumer 116 selects merchant A from the listing of merchants in hit interface 600, for example. To present the information to the consumer 116, the route interface 700 includes a map or layout 702 of the shopping center 114 that identifies, via position indicator 704a, a location of the target product at the selected merchant A. The route interface 700 also includes a pin 706 identifying a present position of the consumer 116 (as determined by a last position statement record received from the portable communication device 118), and a route 708 (as generated by the portable communication device 118 in this example) illustrating a path from the consumer's present position to the selected merchant A. The exemplary route interface 700 further includes a listing 710 of directions to guide the consumer 116 from his/her present position to the merchant A. Again, it should be appreciated that other exemplary route interfaces may be employed, and that the information included in the other interfaces may be different (or displayed differently) than illustrated for route interface 700.

In various embodiments, the product position engine 112 may also provide one or more offers of discounts to the consumer 116 (broadly, ad content) together with one or more of the product entries identified by the product position engine 112 as matching the consumer's requested search criteria (also see Applicant's co-pending US application titled “Systems and Methods for use in Directing Product Offer Content to Consumers,” filed on the same day as the instant application, and Applicant's co-pending US application titled “Systems and Methods for use in Determining Detailed Locations for Certain Entities,” also filed on the same day as the instant application, both of which are incorporated herein by reference in their entireties). The offers may be included with the response from the product position engine 112 transmitting the identified product entries to the portable communication device 118, or they may be provided separately. Specifically, for example, merchant 102a in the system 100 may include a discount price for a product requested by the consumer 116 when the product is offered for sale at the merchant 102a as well as at multiple other merchants within the shopping center 114. Or, the merchant 102a, via the product position engine 112, may provide a unique code to the consumer 116 associated with the product, where the code can then be used by the consumer 116 at checkout to receive the discount price.

For example, a discount offer may be provided by the product position engine 112 based on a particular search query received from the consumer 116 (e.g., an offer related to an iPad® may be provided following a search for tablets, etc.). Additionally, or alternatively, a discount offer may be provided by the product position engine 112 based on a location or position of the consumer 116 in the shopping center 114. Here, an offer relating to one or more products at a merchant in close proximity to the consumer 116 may be provided, by the product position engine 112, to the consumer 116.

In various embodiments, the product position engine 112 may also (or alternatively) provide one or more offers of discounts to the consumer 116 when the consumer 116 enters the shopping center 114 (and/or when the consumer 116 establishes communication, via the consumer's portable communication device 118, with networks provided by the routers 124a-d at the shopping center 114).

For example, a discount offer may be provided by the product position engine 112, when the consumer 116 enters the shopping center 114, based on prior transactions of the consumer 116 (e.g., the consumer's transaction data, etc.). Here, the product position engine 112 may use the ID received from the consumer 116 (specifically, from the consumer's portable communication device 118), for example, when entering the shopping center 114, etc. (typically only upon permission or consent from the consumer 116), to identify the consumer 116 (or to identify a general demographic to which the consumer 116 may belong) and then to identify the relevant transaction data (e.g., access the transaction data at the payment network 106, etc.) for use in providing the discount offer. In addition, or alternatively, a discount offer may be provided by the product position engine 112 based on products included in an electronic shopping cart associated with the consumer 116 or based on products viewed by the consumer 116 at the consumer's portable communication device 118 (again, typically only upon permission or consent from the consumer 116), and provide the discount offer based thereon. Still further, the product position engine 112 may track prior discount offers provided to the consumer 116 and use, or not, of the offers by the consumer 116 (e.g., via suitable identifiers included in the offers such as barcodes, etc.) to determine redemption tendencies of the consumer 116. Here, future offers to the consumer 116 may then be tailored to the consumer 116 based on the consumer's past redemption tendencies.

In various embodiments, an internet-based application on the consumer's portable communication device 118 (or another application on the consumer's portable communication device 118) or on the user's device 122 may cause the communication device 118, 122 to emit a signal, for example, via the network interface 210 (e.g., via an emitter, etc.), which includes a unique application identifier (APP ID) identifying the application, the communication device 118, 122, and/or the consumer 116/user 120. The routers 124a-d then detect the emitted signal from the communication device 118, 122 and the engine 112 determines the consumer's location or the user's location based on emitted signal strengths as detected by each router 124a-d.

In view of the above, the systems and methods herein provide the actual positions of products within merchant locations, so that consumers can readily and easily find them. In addition to product locations, the systems and methods herein provide certain other information about the products that may be used by the consumers to make informed purchasing decisions, particularly when multiple different products are available that are consistent with the consumers' products of interest.

It should be appreciated that the functions described herein, in some embodiments, may be described in computer executable instructions stored on a computer readable media, and executable by one or more processors. The computer readable media is a non-transitory computer readable media. By way of example, and not limitation, such computer-readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following operations: (a) receiving a request for a product from a consumer; (b) accessing a product position data structure, which is specific to the shopping center, where the product position data structure includes multiple product entries, each of the multiple product entries being specific to a merchant within the shopping region; (c) identifying at least one product entry, from the product position data structure, based on the request for the product received from the consumer; (d) causing via an internet-based application, a position of the identified at least one product entry to be displayed at a communication device associated with the consumer, relative to a position of the consumer in the shopping center; (e) receiving, via the internet-based application, at least one position record from the communication device associated with the consumer, where the position record includes a signal strength captured by the communication device for at least one router located at the shopping center; (f) determining the position of the consumer based on the at least one position record; (g) causing at least one ad content to be displayed at the communication device, based on the location of the consumer, within the shopping center; and (h) accessing transaction data for the consumer from a payment network and causing at least one ad content to be displayed at the communication device based on the transaction data.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

In addition, as used herein, the term product may include a good and/or a service.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for locating products within a shopping region, the method comprising:
receiving, at a computing device, a request for a product from a consumer;
accessing, by the computing device, a product position data structure, which is specific to the shopping region, the product position data structure including multiple product entries, each of the multiple product entries being specific to a merchant within the shopping region;
identifying at least one product entry, from the product position data structure, based on the request for the product received from the consumer; and
causing, by the computing device, via an internet-based application, a position of the identified at least one product entry to be displayed at a communication device associated with the consumer, relative to a position of the consumer in the shopping region.

2. The computer-implemented method of claim 1, further comprising:
receiving, at the computing device, via the internet-based application, at least one position record from the communication device associated with the consumer, the position record including a signal strength captured by the communication device for at least one router located at the shopping region; and
determining, by the computing device, the position of the consumer based on the at least one position record.

3. The computer-implemented method of claim 2, wherein receiving the at least one position record includes receiving multiple position records over an interval;
wherein determining the position of the consumer includes determining the position of the consumer based on a last one of the multiple position records; and
further comprising generating a path record for the consumer based on the multiple position records.

4. The computer-implemented method of claim 1, further comprising causing at least one ad content to be displayed at the communication device, based on the location of the consumer, within the shopping region.

5. The computer-implemented method of claim 1, further comprising accessing transaction data for the consumer from a payment network and causing at least one ad content to be displayed at the communication device based on the transaction data.

6. The computer-implemented method of claim 1, wherein the identified at least one product entry includes multiple identified product entries; and
wherein causing, by the computing device, via an internet-based application, a position of the identified at least one product entry to be displayed at the communication device associated with the consumer includes causing a hit interface to be displayed at the communication device, the hit interface including a position for each of the multiple identified product entries.

7. The computer-implemented method of claim 6, further comprising receiving a selection of one of the multiple identified product entries, via the internet-based application, and causing a route interface to be displayed at the communication device, the route interface including a route within the shopping region from the position of the consumer to the position of the selected one of the identified product entries.

8. The computer-implemented method of claim 7, wherein the hit interface includes, for each of the multiple identified product entries, at least a merchant name and a price associated with each of the multiple product entries.

9. The computer-implemented method of claim 6, further comprising associating a discount offer with at least one of the multiple identified product entries, based on the identification of the at least one of the multiple identified product entries from the product position data structure.

10. The computer-implemented method of claim 1, further comprising receiving a position record from a merchant computing device, when the merchant computing device is located proximate to a position of the identified at least one product entry, the position record including multiple router intensities, each indicative of a relative distance between the merchant communication device and a router; and
identifying and storing the position of the identified at least one product entry, based on the position record received from the merchant computing device.

11. A system for use in providing product position in a shopping region, the system comprising:
multiple routers disposed within a shopping region;
a data structure including multiple product entries, each entry associated with a product and a merchant, each entry including a router intensity profile for the product and a merchant name, the router intensity profile including a router intensity for at least two of the multiple routers; and
a processing device coupled to the data structure, the processing device configured to:
search, within the data structure, for product entries based on a product request received from a communication device associated with a consumer, via an internet-based application, the product request identifying at least one of a product name, a product brand, and a product category for use by the processing device in the search; and
generate a hit interface, when at least one of the product entries includes the product name, the product brand, and/or the product category indicated by the product request and cause the hit interface to be displayed at the communication device associated with the consumer, the hit interface including a position and/or a merchant name associated with said at least one of the product entries.

12. The system of claim 11, wherein said at least one of the product entries includes multiple ones of the product entries; and
wherein the hit interface includes an offer for each of said multiple ones of the product entries.

13. The system of claim 12, wherein the hit interface includes, for each of said multiple ones of the product entries, a distance from the consumer to the position associated with the product entry.

14. The system of claim 13, wherein the hit interface includes, for each of said multiple ones of the product entries, the merchant name and a review of a product associated with the product entry.

15. The system of claim 11, further comprising a merchant communication device configured to:
capture one or more intensities from the multiple routers to, in response to a product designation from a user associated with the merchant communication device, record router intensities from at least two of the multiple routers; and
generate one of the product entries based on the recorded router intensities.

16. The system of claim 11, wherein the processing device is configured to receive the multiple product entries from an internet-based application associated with a merchant communication device, and store the received multiple product entries in the data structure.

17. The system of claim 16, wherein the processing device is configured, in connection with receiving the multiple product entries, to cause, via the internet-based application associated with the merchant communication device, a tag interface to be displayed at the merchant communication device for identifying products associated with the multiple product entries.

18. A non-transitory computer readable storage media including instructions for locating products within a shopping region, which when executed by at least one processor, cause the at least one processor to:
access, in response to a product request from a consumer at a shopping region, a product position data structure that is specific to the shopping region, the product position data structure including multiple product entries, each of the multiple product entries being specific to a merchant within the shopping region;
identify at least one product entry, from the product position data structure, based on the product request; and
cause, via an internet-based application, a position of the identified at least one product entry to be displayed at a communication device associated with the consumer, relative to a position of the consumer in the shopping region.

19. The non-transitory computer readable storage media of claim 18, further including instructions, which when executed by the at least one processor, cause the at least one processor to determine the position of the consumer based on at least one position record received from the communication device associated with the consumer, the position record including a signal strength captured by the communication device for at least one router located at the shopping region.

20. The non-transitory computer readable storage media of claim 18, further including instructions, which when executed by the at least one processor, cause the at least one processor to:
identify a position of the at least one product entry based on a position record received from a merchant computing device, when the merchant computing device is located proximate to a position of the at least one product entry, the position record including multiple router intensities, each indicative of a relative distance between the merchant communication device and a router; and
store the identified position of the at least one product entry tin the product position data structure.
